(19) United States
(12) Patent Application Publication
(10) Pub. No.: US 2012/0279521 A1
(43) Pub. Date: Nov. 8, 2012

(54) DISPENSE NOZZLE CLEANER

(75) Inventors: EUGENIO SAMANIEGO VILLARICO, BAGUIO CITY (PH); HARRY MAMON TANOJA, BAGUIO CITY (PH); EDWARD RAPANUT DE LA ROSA, BAGUIO CITY (PH); DENNIS DIAN CASTILLO, BAGUIO CITY (PH)

(73) Assignee: TEXAS INSTRUMENTS INCORPORATED, Dallas, TX (US)

(21) Appl. No.: 13/100,018

(22) Filed: May 3, 2011

(51) Int. Cl. B08B 9/02

(52) U.S. Cl. 134/22.12; 134/166 C

(57) ABSTRACT

A dispense nozzle cleaner includes a cleaning rack having apertures for placement epoxy dispense nozzles including nozzle holes having residual epoxy, spray nozzles, and alignment members for aligning the spray nozzles with the epoxy dispense nozzles. A pressure source coupled to a solvent reservoir in a lower chamber and a pressure source coupled to an upper chamber delivers a pressurized cleaning solution including a solvent or solvent mixture for epoxy from the solvent reservoir to an inlet side of the spray nozzles that are within a middle chamber for urging the pressurized cleaning solution through the spray nozzle to be sprayed from its outlet so that the pressurized cleaning solution sprayed flows through the full length of the epoxy dispense nozzle including through the nozzle hole, thereby removing at least a portion of the residual epoxy.

### FIELD

Disclosed embodiments relate to cleaning of dispense nozzles that dispense epoxy using a chemical treatment, and dispense nozzle cleaners.

### BACKGROUND

Dispense nozzles that dispense epoxy-based materials are used in a variety of semiconductor assembly systems, such as for die attach and die molding systems. In the case of die attach systems, dispense nozzles are commonly used. Partially cured epoxy is known to accumulate on the dispense nozzle holes during use, which results in the need for periodic cleaning of the dispense nozzles to clear blockages for proper dispensing.

The conventional dispense nozzle cleaning process is an exclusively manual operative intensive process. In such a cleaning process, dispense nozzles are soaked in a ultrasonic tank filled with a solvent for softening partially cured epoxy, such as acetone which is known to soften partially cured epoxy. As the dispense nozzles are soaked, the operator picks up the dispense nozzles individually from the solvent solution and uses a wire to pass through the nozzle hole using a back and forth scraping motion to weaken the epoxy bond, which can deform the nozzle tip. The nozzle is then soaked in the solvent which can wash off some of the softened epoxy. A pressurized air or nitrogen gun can also be used to help push the softened epoxy out of the nozzle holes, followed by a rinse in a tank with the epoxy solvent (e.g., acetone) to complete the cleaning process.

The cleaning time for this conventional method is typically about 1 to 2 hours. This conventional cleaning method exposes the operator to solvent fumes as it rapidly evaporates, and moreover epoxy is splattered over the work area. The conventional dispense nozzle cleaning process thus creates a potential health hazard as well as a work area cleanliness problem.

### SUMMARY

Disclosed embodiments describe dispense nozzle cleaning machines that eliminate or at least reduce clogged and worn-out dispense nozzles due to conventional manual dispense nozzle cleaning that utilizes a wire or similar object for scraping away loosened epoxy. Disclosed embodiments include automated cleaning of dispenser nozzles by directly spraying pressurized epoxy solvents at the dispense nozzles to remove the residual epoxy. A reduced safety risk due to chemical exposure is provided because dispense nozzle cleaning can be performed automatically unlike conventional manual cleaning where the operator is exposed to fumes from the volatile epoxy solvent (e.g., acetone) for hours. Moreover, since disclosed dispense nozzle cleaners are sealed, disclosed embodiments eliminate epoxy splattering over the work area.

One embodiment comprises a dispense nozzle cleaner that includes a cleaning rack having at least one aperture for placement of at least one epoxy dispense nozzle having a nozzle hole and residual epoxy, at least one spray nozzle, and at least one alignment member for aligning the spray nozzle with the epoxy dispense nozzle so that liquid sprayed from the spray nozzle flows through a full length of the epoxy dispense nozzle. A pressure source coupled to a solvent reservoir is for delivering a pressurized cleaning solution including a solvent or solvent mixture for epoxy to an inlet side of the spray nozzle for urging the pressurized cleaning solution through the spray nozzle to be sprayed from its outlet so that the pressurized cleaning solution sprayed flows through the full length of the epoxy dispense nozzle including through the nozzle hole, thereby removing at least a portion of the residual epoxy.

### BRIEF DESCRIPTION OF THE DRAWINGS

FIG. 1 is a flow chart that shows steps in an example method of cleaning residual epoxy from epoxy dispense nozzles, according to an example embodiment.

FIG. 2A is a depiction of the outside of an example dispense nozzle cleaner, according to an example embodiment.

FIG. 2B is a sectional view showing inside parts of an example dispense nozzle cleaner, according to an example embodiment.

FIG. 2C is a up close sectional depiction showing details of components including the spray nozzle, dispense nozzle and cleaning rack within an example middle chamber, according to an example embodiment.

FIG. 3 is a simplified dispense nozzle cleaner depiction showing a closed loop fluid path and pressure sources exclusive of any pumps for flowing solvent during an example cleaning process, according to an example embodiment.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

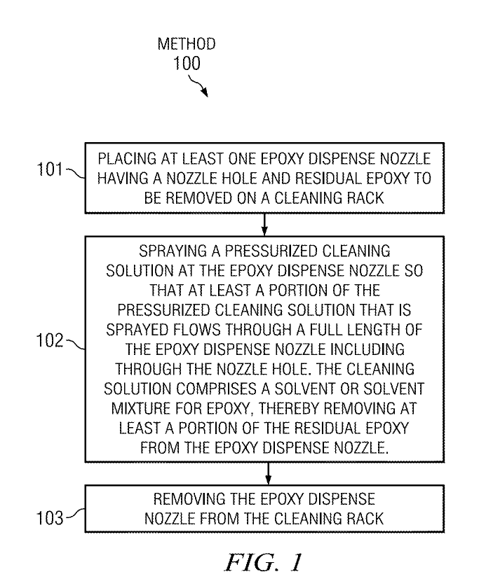

FIG. 1 is a flow chart that shows steps in an example method 100 of cleaning of residual epoxy from epoxy dispense nozzles, according to an example embodiment. Step 101 comprises placing at least one epoxy dispense nozzle having a nozzle hole and residual epoxy to be removed on a cleaning rack. The cleaning rack generally includes at least one hole (or aperture) for receiving the epoxy dispense nozzle and a securing member for securing the epoxy dispense nozzle to the cleaning rack. The cleaning rack can comprise a plate having a plurality of holes that provides different sizes to fit a plurality of different epoxy nozzle sizes. The placing of the epoxy dispense nozzles can comprise manual placement by an operator.

Step 102 comprises spraying a pressurized cleaning solution at the epoxy dispense nozzle so that at least a portion of the pressurized cleaning solution that is sprayed flows through a full length of the epoxy dispense nozzle including through the nozzle hole. The cleaning solution comprises a solvent or solvent mixture for epoxy, thereby removing at least a portion of the residual epoxy from the dispense nozzle. Since the residual epoxy is removed solely by action of the pressurized solvent, disclosed methods eliminate or at least reduce clogged and worn-out dispenser nozzles due to conventional manual dispense nozzle cleaning that utilizes a wire or similar object for scraping loosened epoxy. Example solvents for uncured or partially cured epoxy include denatured alcohol, acetone, and toluene, or mixtures thereof.

The spraying can comprise automatically spraying the pressurized cleaning solution for a pre-programmed time. The automatically spraying can comprise using a pressurized gas, such as pressurized air or pressurized nitrogen, to force the transfer of the epoxy solvent from a cleaning solution reservoir storing the epoxy solvent to the epoxy dispense nozzles via spray nozzles that are aligned with the epoxy dispense nozzles so that the epoxy solvent flows through a full length of the epoxy dispense nozzles.

Disclosed methods are generally practiced exclusive of any pump. This aspect helps reduce the fire danger associated with the epoxy solvent.

Step 103 comprises removing the epoxy dispense nozzles from the cleaning rack. Using disclosed methods and cleaners the operator' involvement time during cleaning can be reduced from 1 to 2 hours typical for manual epoxy dispense nozzle cleaning to around 0.2 man-hours due to the automation of the epoxy dispense nozzle cleaning (step 102) provided by disclosed dispense nozzle cleaners. Operators only load epoxy dispense nozzles onto the cleaning rack (step 101) and unload epoxy dispense nozzles from the cleaning rack (103). The operator time saved allows the operator to perform other jobs.

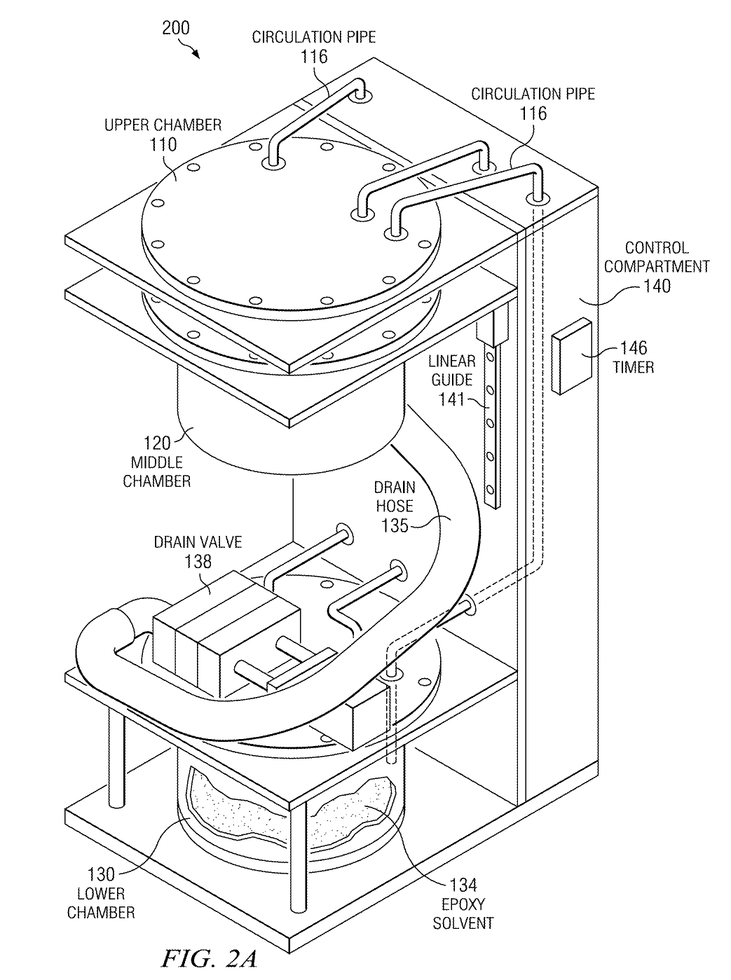

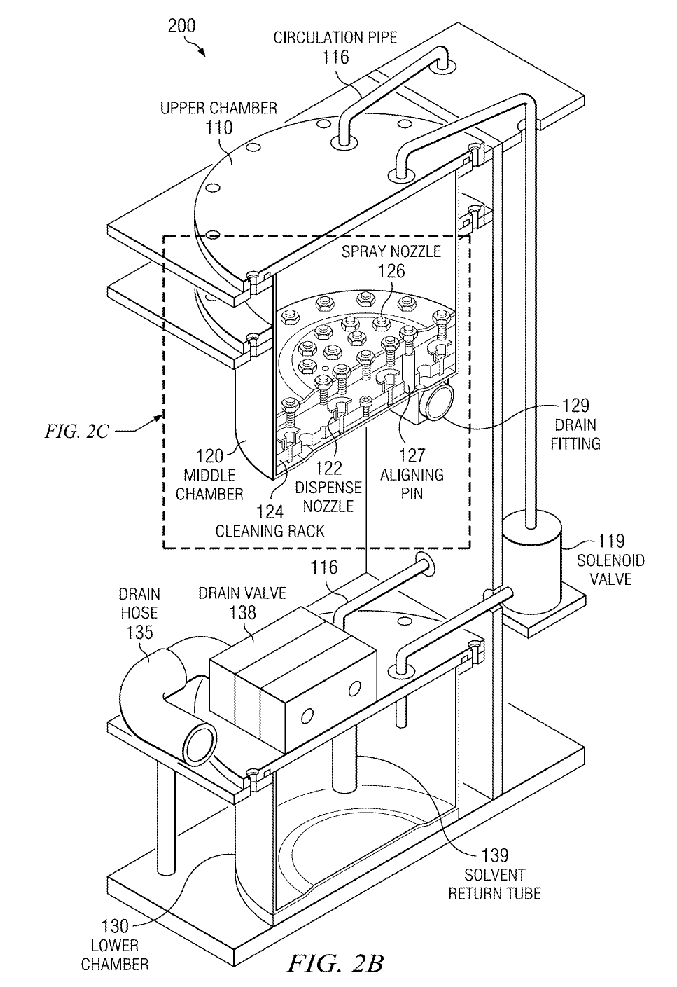

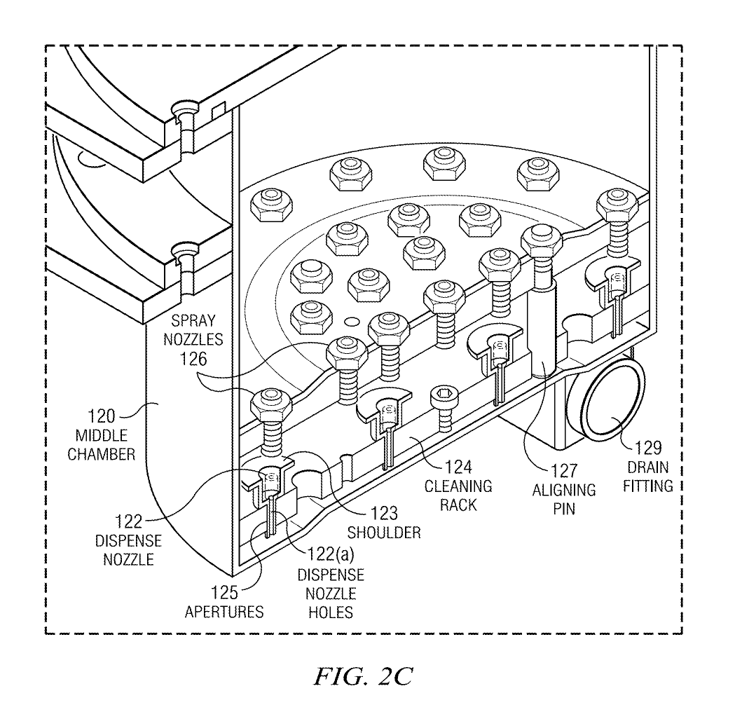

FIG. 2A is a depiction of the outside of an example dispense nozzle cleaner 200, while FIG. 2B is a sectional view showing inside parts of the dispense nozzle cleaner 200, and FIG. 2C is a up close sectional depiction showing details of components including the spray nozzle, dispense nozzle and cleaning rack within an example middle chamber, according to an example embodiment. Dispense nozzle cleaner 200 includes an upper chamber 110, a middle chamber 120, and a lower chamber 130. A drain hose 135 transfers effluent comprising the epoxy solvent after spraying from the middle chamber 120 through the epoxy dispense nozzles to the lower chamber under influence of gravity via drain valve 138. The dispense nozzle cleaner 200 thus recirculates the solvent. Dispense nozzle cleaners such as dispense nozzle cleaner 200 are also airtight (sealed).

Circulation pipes 116 are for transferring pressurized epoxy solvent 134 from the lower chamber 130 to the upper chamber 110. The solenoid valve 119 shown in FIG. 2B is in the path the circulation pipes 116. A control compartment 140 includes electronics including timer 146 that controls times including cleaning (i.e., spraying) times, as well as controllers that control actuation of valves in the dispense nozzle cleaner 200. A buzzer can be provided to automatically sound an alert to alert the operator of the end of cleaning cycle.

The cleaning time can depend on the time set on the timer. The linear guide 141 ensures that the middle chamber 120 will move in a straight vertical line during its downward or upward movement.

As shown in FIGS. 2B and 2C the middle chamber 120 includes a plurality of epoxy dispense nozzles 122 on a cleaning rack 124 that includes a plurality of apertures 125 for receiving the epoxy dispense nozzles 122 and a plurality of spray nozzles 126 aligned with the epoxy dispense nozzles 122 by aligning pins 127 so that pressurized cleaning solution including the epoxy solvent 134 that is sprayed flows from spray nozzles 126 flows through a full length of the epoxy dispense nozzles 122, including through the dispense nozzle holes 122(a). The body of the epoxy dispense nozzles fits on the aperture 125 on the cleaning rack 124, and the cleaning rack 124 includes securing members for securing the epoxy dispense nozzles 122 to the cleaning rack 124 shown as nozzle shoulders 123. The nozzle shoulders 123 together with the top surface of the cleaning rack 124 serve as stoppers for preventing the epoxy dispense nozzles 122 from slipping through the apertures 125.

A lower chamber 130 provides the cleaning solution reservoir that holds the epoxy solvent 134. In operation of dispense nozzle cleaner 200, pressurized gas forces transfer of the epoxy solvent 134 from the lower chamber 130 to the upper chamber 110 then to the plurality of spray nozzles, then through the epoxy dispense nozzles 122 in the middle chamber 120, and then back to lower chamber 130 by drain fitting 129 coupled to drain valve 138 which is coupled to solvent return tube 139.

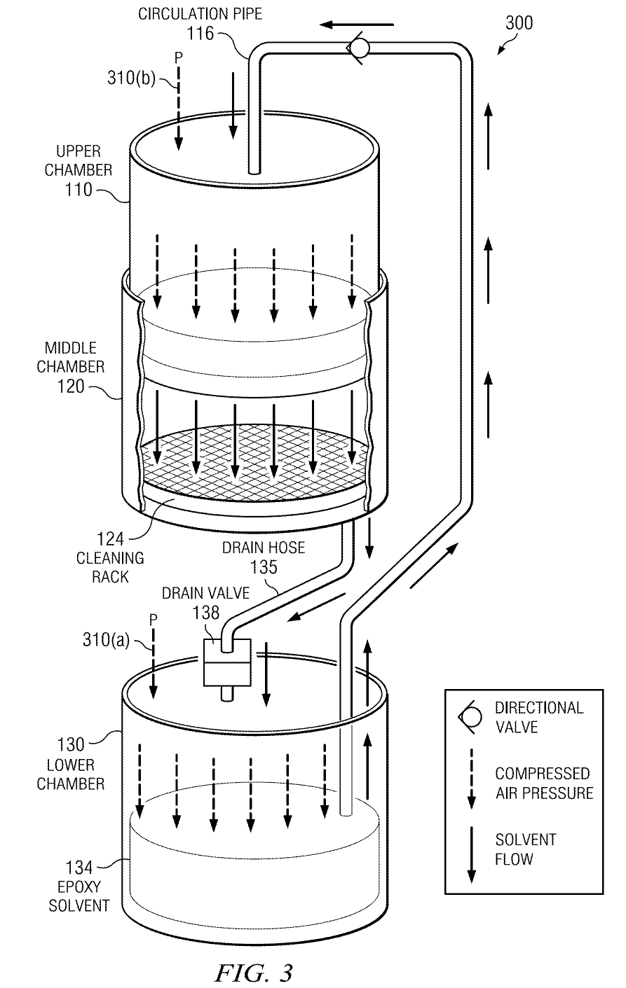

FIG. 3 is a simplified dispense nozzle cleaner depiction 300 showing a closed loop fluid path and pressure sources exclusive of any pumps for flowing epoxy solvent 134 during an example cleaning process, according to an example embodiment. The cleaner uses a pressurized gas such as air pressure from a pressure source 310(a) to propel the epoxy solvent 134 from a reservoir in the lower chamber 130 to the upper chamber 110 and a pressure source 310(b) to propel the epoxy solvent from the upper chamber 110 to the spray nozzles in the middle chamber 120 which are aligned with epoxy dispense nozzles. The arrangement shown in FIG. 3 eliminates the use of a pump. There is thus a reduced fire hazard by using a compressed gas such as air or nitrogen instead of a conventional pump (e.g., since the epoxy solvents are generally flammable).

As described above, the middle chamber 120 is where the epoxy dispense nozzles having residual epoxy to be cleaned are positioned on the cleaning rack 124. The middle chamber 120 can provide an upper position, which is the cleaning position, and a lower position, which is an epoxy solvent replenishment position. The lower position is where operators can place and remove the epoxy dispense nozzles. It is also a position where the epoxy solvent may be added, such as acetone. The linear guide 141 described above allows the middle chamber 120 to move in a straight vertical line during its downward or upward movement when switching between lower and upper positions.

In operation, the epoxy solvent can be poured into the middle chamber and flows through the drain hose 135 then to the lower chamber 130. Once the lower chamber 130 is filled with epoxy solvent 134, the drain valve 138 can be closed and compressed gas, such as compressed air or nitrogen, can be introduced. As the pressure on the lower chamber increases, it will force the epoxy solvent 134 into the upper chamber 110 through the circulation pipes 116. When the solvent 134 is finished transferring to the upper chamber 110, a compressed gas valve on the lower chamber 130 can close.

Since the upper chamber 110 is now filled with epoxy solvent 134, compressed gas can then be activated to increase the pressure on the upper chamber 110 and push the epoxy solvent 134 to the spray nozzles in the middle chamber 120. The spray nozzles which are aligned to the epoxy dispense nozzles will bombard the epoxy dispense nozzles with the epoxy solvent 134 at high velocity and pressure to push the residual epoxy through the nozzle holes. The sprayed epoxy solvent 134 that passes through the dispense nozzle holes will be returned back to the lower chamber 130 through the drain hose 135.

Example settings include a refilling time of 8 seconds, a cleaning time of 20 seconds, and a process time of 1 hour. The process time can comprise a repetitive cycle of refilling and cleaning steps for the process time, such as 1 hour. The lower chamber pressure and upper chamber pressure while pressurized can be at least 0.2 MPa. As described above, pressurization of the chambers forces flow of epoxy solvent 134 from one chamber to another during the refilling and cleaning cycles.

Although disclosed embodiments are described for cleaning dispense nozzles for a die bonder, disclosed embodiments can be applied to clean other nozzles that dispense epoxy resin. More generally, disclosed embodiments can be integrated into a variety of assembly flows that involve epoxy dispensing though epoxy dispense nozzles to form a variety of different IC devices and related products. Those skilled in the art to which this disclosure relates will appreciate that many other embodiments and variations of embodiments are possible within the scope of the claimed invention, and further additions, deletions, substitutions and modifications may be made to the described embodiments without departing from the scope of this disclosure.

We claim:

1. A method of cleaning epoxy dispense nozzles, comprising:
placing at least one epoxy dispense nozzle having a nozzle hole and residual epoxy to be removed on a cleaning rack, and
spraying a pressurized cleaning solution at said epoxy dispense nozzle so that at least a portion of said pressurized cleaning solution that is sprayed flows through a full length of said epoxy dispense nozzle including through said nozzle hole, wherein said cleaning solution includes a solvent or solvent mixture for epoxy, thereby removing at least a portion of said residual epoxy from said epoxy dispense nozzle.

2. The method of claim 1, wherein said cleaning rack includes at least one aperture for receiving said epoxy dispense nozzle and a securing member for securing said epoxy dispense nozzle to said cleaning rack.

3. The method of claim 1, wherein said spraying comprises automatically spraying said pressurized cleaning solution for a pre-programmed time.

4. The method of claim 3, wherein said automatically spraying comprises using a pressured gas to force transfer of said cleaning solution from a cleaning solution reservoir storing said cleaning solution.

5. The method of claim 4, wherein said pressurized gas is provided by a pressured gas source, and said method is practiced exclusive of a pump.

6. The method of claim 4, wherein said method is practiced using a dispense nozzle cleaner comprising:
an upper chamber;
a middle chamber that includes a plurality of said epoxy dispense nozzles on said cleaning rack that includes a plurality of said apertures for receiving said plurality of said epoxy dispense nozzle and a plurality of spray nozzles aligned with said plurality of epoxy dispense nozzles so that pressurized cleaning solution that is sprayed flows through said full length of said plurality of epoxy dispense nozzles including through said nozzle holes, and
a lower chamber that provides said cleaning solution reservoir,
wherein said pressurized gas forces transfer of said cleaning solution from said lower chamber to said upper chamber then to said plurality of spray nozzles.

7. The method of claim 6, wherein said dispense nozzle cleaner further comprises at least one alignment member for aligning said plurality of spray nozzles with associated ones of said plurality of epoxy dispense nozzles so that said pressurized cleaning solution flows from said plurality of spray nozzles to said plurality of epoxy dispense nozzles.

8. The method of claim 6, further comprising a drain hose coupled to said middle chamber for receiving effluent comprising said solvent or said solvent mixture and flowing said effluent under influence of gravity to said lower chamber system into said cleaning solution reservoir, wherein said dispense nozzle cleaner is an airtight and recirculating system.

9. A dispense nozzle cleaner, comprising:
a cleaning rack having at least one aperture for placement of at least one epoxy dispense nozzle having a nozzle hole and residual epoxy to be removed;
at least one spray nozzle;
at least one alignment member for aligning said spray nozzle with said epoxy dispense nozzle so that liquid sprayed from said spray nozzle flows through a full length of said epoxy dispense nozzle including through said nozzle hole;
a pressure source coupled to a solvent reservoir for delivering a pressurized cleaning solution comprising a solvent or solvent mixture for epoxy to an inlet side of said spray nozzle for urging said pressurized cleaning solution through said spray nozzle to be sprayed from its outlet so that said pressurized cleaning solution that is sprayed flows through said full length of said epoxy dispense nozzle including through said nozzle hole, thereby removing at least a portion of said residual epoxy from said epoxy dispense nozzle.

10. The dispense nozzle cleaner of claim 9, wherein said cleaning rack includes a securing member for securing said epoxy dispense nozzle to said cleaning rack.

11. The dispense nozzle cleaner of claim 9, further comprising a timer for setting a time for spraying said pressurized cleaning solution.

12. The dispense nozzle cleaner of claim 9, wherein said pressure source comprises at least one pressurized gas source, and wherein said dispense nozzle cleaner exclusive of a pump.

13. The dispense nozzle cleaner of claim 12, wherein said dispense nozzle cleaner comprises:
an upper chamber;
a middle chamber that includes a plurality of said epoxy dispense nozzles on said cleaning rack that includes a plurality of said apertures for receiving said plurality of said epoxy dispense nozzle and a plurality of spray nozzles aligned with said plurality of epoxy dispense nozzles so that pressurized cleaning solution that is sprayed flows through said full length of said plurality of epoxy dispense nozzles including through said nozzle holes, and
a lower chamber that provides said cleaning solution reservoir,
wherein said pressurized gas forces transfer of said cleaning solution from said lower chamber to said upper chamber then to said plurality of epoxy spray nozzles.

14. The dispense nozzle cleaner of claim 13, wherein said dispense nozzle cleaner further comprises at least one alignment member for aligning said plurality of spray nozzles with associated ones of said plurality of epoxy dispense nozzles so that said pressurized cleaning solution flows from said plurality of spray nozzles to said plurality of epoxy dispense nozzles.

15. The dispense nozzle cleaner of claim 13, further comprising a drain hose coupled to said middle chamber for receiving effluent comprising said solvent or said solvent mixture and flowing said effluent under influence of gravity to said lower chamber system into said cleaning solution reservoir, wherein said dispense nozzle cleaner is an airtight and recirculating system.
